(19) United States
(12) Patent Application Publication
(10) Pub. No.: US 2026/0235988 A1
(43) Pub. Date: Aug. 13, 2026

(54) SWITCH DEVICE, TIMEPIECE, AND METHOD FOR MANUFACTURING SWITCH DEVICE

(71) Applicant: CASIO COMPUTER CO., LTD., Tokyo (JP)

(72) Inventor: Takamaro MIYAZAWA, Tokyo (JP)

(21) Appl. No.: 19/531,067

(22) Filed: Feb. 5, 2026

(30) Foreign Application Priority Data
Feb. 7, 2025 (JP) 2025-018869

(51) Int. Cl. G04B 3/04; G04B 37/10

(52) U.S. Cl. CPC G04B 3/048; G04B 37/106

(57) ABSTRACT

A switch device includes: a case that has a through hole penetrating through an inside to an outside; and an operation member that includes: an operation shaft, one end of the operation shaft being inserted in the through hole of the case from the outside of the case; and an operation head that is fixed to another end of the operation shaft. The operation head of the operation member includes: a shaft locking portion fixed to the operation shaft by covering at least a predetermined angular region in a circumferential direction of an outer periphery of the operation shaft; and a cover that covers at least a portion of an outer periphery of the shaft locking portion in an axial direction of the operation shaft. An inner peripheral wall of the cover is connected to the shaft locking portion via a rib.

### CROSS-REFERENCE TO RELATED APPLICATION

This application is based upon and claims the benefit of priority from the prior Japanese Patent Application No. 2025-018869, filed on February 7, 2025, the entire contents of which are incorporated herein by reference.

### BACKGROUND OF THE INVENTION

### TECHNICAL FIELD

This invention relates to a switch device, a timepiece, and a method for manufacturing a switch device.

### DESCRIPTION OF RELATED ART

For example, JP 2022-033435A describes a timepiece that includes an operation member including: a shaft slidably inserted in an insertion hole of a tubular member attached to a through hole of a case; and a head provided at the end of the shaft.

### SUMMARY OF THE INVENTION

A switch device according to the present invention comprises: a case that has a through hole penetrating through an inside to an outside; and an operation member that includes: an operation shaft, one end of the operation shaft being inserted in the through hole of the case from the outside of the case; and an operation head that is fixed to another end of the operation shaft, wherein the operation head of the operation member includes: a shaft locking portion that is fixed to the operation shaft by covering at least a predetermined angular region in a circumferential direction of an outer periphery of the operation shaft; and a cover that covers at least a portion of an outer periphery of the shaft locking portion in an axial direction of the operation shaft, and an inner peripheral wall of the cover is connected to the shaft locking portion via a rib.

### BRIEF DESCRIPTION OF DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is a front view of a timepiece according to an embodiment;

FIG. 2 is an enlarged view of a major portion of portion II illustrated in FIG. 1;

FIG. 3 is a cross-sectional side view of a major portion of an operation member of a timepiece according to an embodiment and its surrounding region;

FIG. 4 is a plan view of the operation member when viewed from an operation head in the axial direction of an operation shaft;

FIG. 5 is a cross-sectional view taken along line V-V illustrated in FIG. 4;

FIG. 6 is a cross-sectional side view of a major portion of an operation member of a timepiece according to a variation and its surrounding region; and

FIG. 7 is a plan view of the operation member according to the variation when viewed from an operation head in the axial direction of an operation shaft.

### DETAILED DESCRIPTION OF THE INVENTION

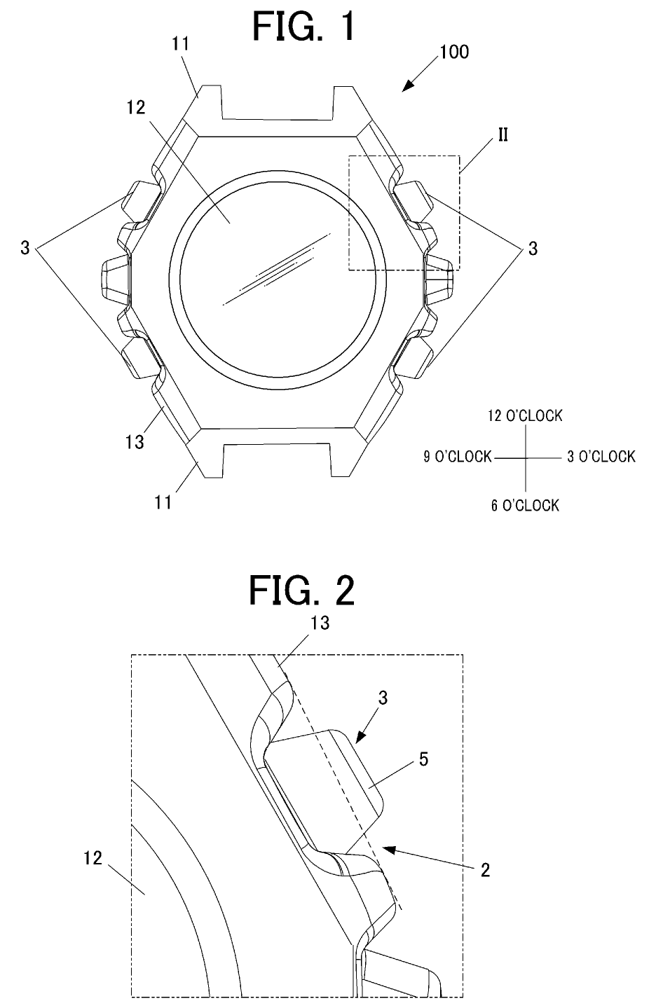

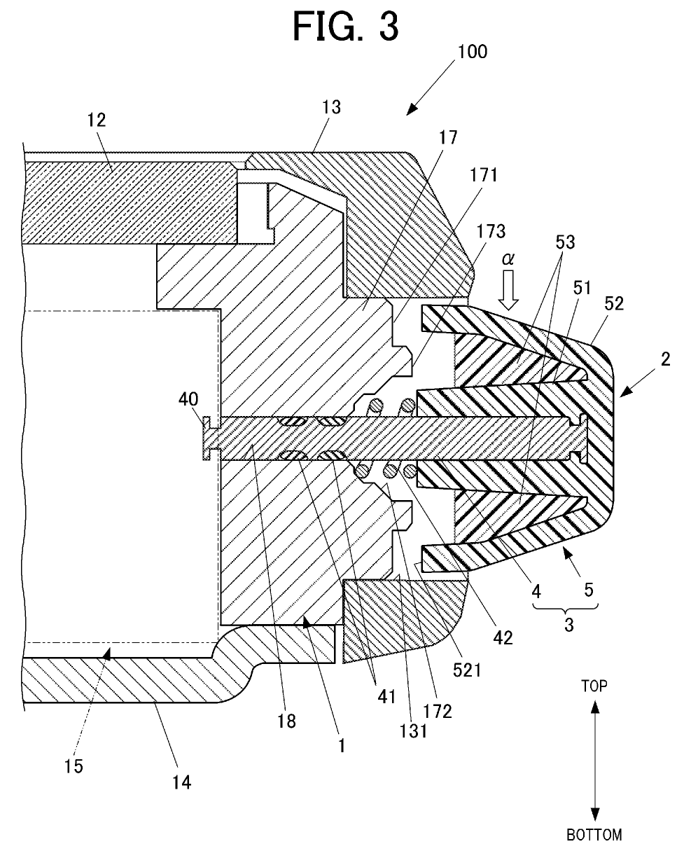

An embodiment of a switch device according to the present invention and a timepiece including the switch device will be described with reference to FIGS. 1 to 5. In the present embodiment, the timepiece is assumed to be a wristwatch (hereinafter simply referred to as "timepiece 100") worn on the wrist. In FIG. 1, a band for wearing the timepiece on the wrist is not shown. Hereinafter, the front side of the timepiece (the visible side) is referred to as the top side, and the back side (the non-visible side, the wrist-wearing side) is referred to as the bottom side (see FIG. 3). The "12 o’clock direction," "6 o'clock direction," "3 o'clock direction," and "9 o'clock direction" of the timepiece refer to those shown in FIG. 1, corresponding to conventional analog timepiece positions. The embodiment described below is provided with various limitations technically preferable for carrying out the present invention. However, the scope of the present invention is not limited to the following embodiment or illustrated examples.

The timepiece 100 includes a switch device 2 including a case 1. As illustrated in FIGS. 1 and 3, the case 1 is a tubular member extending in a top-bottom direction, which is the thickness direction of the timepiece 100, and is formed, for example, from various relatively hard synthetic resins. While the case 1 preferably possesses a certain degree of strength, the material constituting the case 1 is not limited to those exemplified herein. The case 1 may also be formed from metallic materials such as stainless steel (SUS), titanium, or aluminum. In the illustrated example, the case 1 and the timepiece 100 including the case 1 are shown to be substantially circular in plan view. However, the shape of the case 1 and the timepiece 100 is not limited to circular and may also be elliptical or rectangular, for example. The case 1 includes band attachment portions 11, to which a band (not shown) is attached. The band attachment portions 11 are positioned at two locations, for example, at the 12 o'clock position and the 6 o'clock position on an analog timepiece.

In the embodiment, the case 1 is formed into a short cylindrical shape with openings at the top and bottom, creating a hollow internal housing space. As illustrated in FIG. 3, a watch glass 12 is attached to the opening on the top side (the front side of the timepiece 100) of the case 1, covering the top opening. The watch glass 12 is formed from transparent glass, for example. Furthermore, an outer casing member 13, such as a bezel, is provided on the outside of the case 1, surrounding the watch glass 12. As illustrated in FIG. 3, the outer casing member 13 in this embodiment extends from the top side over the side surfaces of the case 1. The opening on the bottom side (the back side of the timepiece 100) of the case 1 is closed by a back cover member 14. A module 15 (indicated by a two-dot chain line in FIG. 3) is disposed within the housing space inside the case 1, between the watch glass 12 and the back cover member 14. The module 15 constitutes a functional unit that operates the timepiece 100, including, for example, a circuit board (not shown) and various electronic components.

The outer peripheral surface of the case 1 is configured to allow operation members 3 to be mounted as appropriate. The number and arrangement of the operation members 3 are not limited. However, in the embodiment, as illustrated in FIG. 1, the operation members 3 are provided at four positions, approximately the "2 o'clock position," "4 o'clock position," "8 o'clock position," and "10 o'clock position" on the timepiece 100. In the embodiment, each of the operation members 3 constitutes a push-button switch and includes an operation shaft 4 and an operation head 5. At the mounting location for the operation member 3 on the outer peripheral surface of the case 1, an operation member mounting portion 17 protruding from the outer periphery of the case 1 is formed. A through hole 18 penetrating the case 1 through the inside to the outside is formed substantially at the center of the operation member mounting portion 17. In FIG. 3, the protruding side of the operation member mounting portion 17 is referred to as an end face 171. Furthermore, around the through hole 18, at the approximate center of the end face 171 of the operation member mounting portion 17, a recess 172 is formed. The recess 172 is indented in the insertion direction of the operation shaft 4 relative to the end face 171. The periphery of the recess 172 forms a guide portion 173 that protrudes slightly outward relative to the end face 171. The guide portion 173 guides the operation member 3, particularly the operation shaft 4, to slide straight in the through hole 18. Preventing the operation shaft 4 from wobbling also reduces swaying of the operation head 5 and prevents bending of the operation shaft 4. In the embodiment, the switch device 2 includes the operation members 3 and the case 1 in which the operation shafts 4 of the respective operation members 3 are inserted.

The operation shaft 4 of the operation member 3 is a shaft formed from a material harder than the operation head 5, with one end inserted in the through hole 18 from the outside of the case 1. In the embodiment, the operation shaft 4 is formed from various metallic materials. The metallic material forming the operation shaft 4 is preferably a relatively high-strength material, such as duplex stainless steel. This allows for increased impact resistance without changing the shaft diameter of the operation shaft 4. Note that the material forming the operation shaft 4 is not limited to this. Furthermore, packings 41 are provided on the portions of the operation shaft 4 inserted in the through hole 18 to ensure airtightness. The operation shaft 4 is configured such that when the operation member 3, which constitutes the push-button switch, is pushed toward the case 1, the operation shaft 4 presses an unillustrated contact portion provided in the module 15, enabling switch operation. Specifically, when the operation member 3 is pushed toward the case 1, an end portion 40 of the one end of the operation shaft 4 inserted in the case 1 directly or indirectly presses the contact portion of the module 15, performing switching. An elastic member is attached to the operation shaft 4 closer to the other end than the positions where the packings 41 are provided. The elastic member is to return the operation member 3 to its original position when the operation member 3 is pushed toward the case 1. In the embodiment, the elastic member is, for example, a coil spring 42 as illustrated in FIG. 3. The coil spring 42 is disposed within the recess 172, with one end abutting an end face of a shaft locking portion 51 of the operation head 5 described later. When the operation member 3 is pressed in, the coil spring 42 compresses. When the pressing force is removed, the coil spring 42 pushes the shaft locking portion 51 back to its original position.

The operation head 5 is fixed to the other end of the operation shaft 4 and is the portion operated by the user's hand. Of the operation member 3, at least the operation head 5 protrudes from the side surface of the outer surface of the case 1. Here, the "case 1" includes the outer casing member 13, such as a bezel, when the outer casing member 13 is provided to cover the side surface of the case 1 as in the embodiment (see FIG. 3). That is, as illustrated in FIGS. 1 and 2, at least a portion of the operation head 5 of the operation member 3 in the embodiment protrudes outward beyond the outermost line (dashed line in FIG. 2) of the case 1 (case 1 and outer casing member 13). In the embodiment, the operation head 5 is formed from resin. This allows for easy realization of various colors and shapes, resulting in excellent design. Thus, the operation head 5 is formed from a material softer than the operation shaft 4. Note that the case 1 has a higher hardness than the operation head 5. For example, even when the case 1 is formed from resin, the resin used to form the case 1 has a higher hardness than the resin used to form the operation head 5. The operation head 5 includes the shaft locking portion 51 fixed to the operation shaft 4 and a cover portion (cover) 52. The shaft locking portion 51 is fixed to the operation shaft 4 by covering at least a predetermined angular region in the circumferential direction of the outer periphery of the operation shaft 4. In the embodiment, the shaft locking portion 51 covers the entire circumferential direction of the outer periphery of the operation shaft 4.

As illustrated in FIGS. 3 and 5, the cover portion 52 is an umbrella-shaped portion that is provided on the outer side of the shaft locking portion 51 and opens toward the case 1. The shaft locking portion 51 protrudes toward the case 1 from the inner side of the top surface of the cover portion 52. The other end of the operation shaft 4 is fitted into substantially the center of the shaft locking portion 51, and the shaft locking portion 51 and the operation shaft 4 are integrated into a single unit. The shape of the cover portion 52 is not limited to the illustrated example and may be, for example, more rounded overall than in the illustrated example. The cover portion 52 need only cover at least a portion of the outer periphery of the shaft locking portion 51. In the illustrated example, the cover portion 52 has approximately the same length as the shaft locking portion 51 (see FIGS. 3 and 5). However, the cover portion 52 may extend longer than the shaft locking portion 51 in the axial direction of the operation shaft 4 or may be shorter than in the illustrated example.

When the outer casing member 13 is provided outside the case 1 as in the embodiment, the outer casing member 13 has through holes 131, each corresponding to the operation member 3. At least the operation shaft 4 can be inserted through its corresponding through hole 131. In the embodiment, the operation member mounting portions 17 protrude into the respective through holes 131 from the case 1 (inner side). The outer casing member 13 is positioned by the protrusion of the operation member mounting portions 17 into the respective through holes 131, thereby preventing displacement. Furthermore, in the embodiment, a portion of the cover portion 52 of the operation head 5 is inserted into the corresponding through hole 131 from the outside. When the operation member 3 is pushed toward the case 1 by the user, the operation head 5 can be pushed in until an end face 521 of the cover portion 52 facing the case 1 abuts the end face 171 of the operation member mounting portion 17. However, at least when the operation member 3 is not pushed toward the case 1, the cover portion 52 and the case 1 do not contact or interfere with each other. Furthermore, in the embodiment, the guide portion 173 of the operation member mounting portion 17 protrudes outward beyond the end face 171. However, the guide portion 173 is located radially within the inner periphery of the cover portion 52, and its protrusion height is set so that, at least when the operation member 3 is not pushed toward the case 1, the guide portion 173 does not intrude into the interior space of the cover portion 52. If the guide portion 173 were larger than the illustrated example and interfered with the operation head 5, particularly the cover portion 52, then when a force is applied in the direction α indicated by the white arrow in FIG. 3, the operation head 5 would be pushed toward the case 1. This could cause the operation head 5 to crack (break) or deform due to stress from the case 1. In this respect, in the embodiment, the guide portion 173 is configured within a range that does not interfere with the operation member 3, ensuring a wide clearance between the guide portion 173 of the case 1 and the operation member 3 (operation head 5). Consequently, when subjected to an external impact, there is no risk of the operation head 5 of the operation member 3 hitting the case 1 and cracking or being damaged. Alternatively, the guide portion 173 may be omitted from the operation member mounting portion 17, resulting in a configuration where no part protrudes beyond the end face 171.

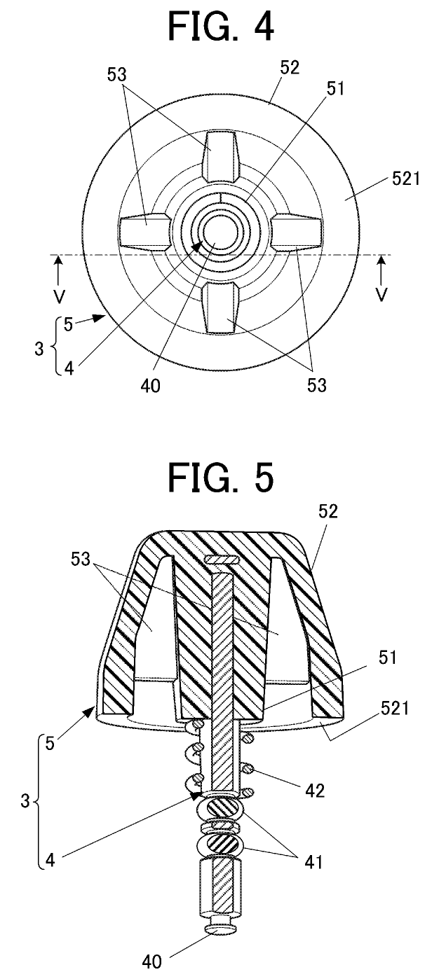

In the embodiment, a portion of the inner peripheral wall of the cover portion 52 is connected to the shaft locking portion 51 via connection portions (ribs) 53. Each of the connection portions 53 is, for example, a thin-walled rib. In the embodiment, as illustrated in FIG. 4, the connection portions 53 are provided in a substantially cross-shaped manner to surround the operation shaft 4 when viewed in the axial direction of the operation shaft 4 toward the operation head 5. Connecting the cover portion 52 to the shaft locking portion 51 via the connection portions 53 enhances the strength of the operation head 5, preventing crushing, cracking, deformation, or the like of the operation head 5 when subjected to impact. The range in which the connection portions 53 are provided is set appropriately. In the illustrated example, each of the connection portions 53 extends from the base end side of the shaft locking portion 51 protruding from the cover portion 52 to the opening side of the cover portion 52. Furthermore, to prevent the connection portions 53 from contacting the guide portion 173 or the like of the case 1 even when the operation member 3 is pushed toward the case 1, on the opening side of the cover portion 52, the connection portions 53 are provided so that end faces of the connection portions 53 on the side facing the case 1 are positioned inside the end face 521 (see cross-sections in FIGS. 3 and 5).

Next, the operation of the switch device 2 according to the present embodiment and the timepiece 100 including the switch device 2 will be described. In the operation member 3 of the switch device 2 according to the embodiment, the operation head 5 is formed, for example, by injection molding of resin. Specifically, heated resin is injected into a mold and cooled to solidify, forming the operation head 5 including the shaft locking portion 51, the cover portion 52, and the connection portions 53. Generally, resin expands when heated and contracts when cooled. Consequently, depending on the mold configuration and other factors, depressions called "sink marks" tend to form on the surface of the molded product as the resin cools. Such surface depressions degrade the appearance of the operation head 5. "Sink marks" are more likely to occur where the resin is thicker. Therefore, in the embodiment, the entire cover portion 52—specifically, the top surface of the cover portion 52 where the shaft locking portion 51 protrudes and the side portions covering the outer periphery of the shaft locking portion 51—is made thin, and the shaft locking portion 51 and the cover portion 52 are connected via the thin, rib-like connection portions 53. This configuration makes the surface less prone to sink marks compared to, for example, a configuration in which the interior of the umbrella-shaped cover portion 52 is filled with resin to increase strength. Furthermore, by arranging the connection portions 53 at four locations nearly evenly around the circumference of the shaft locking portion 51, as illustrated in FIG. 4, the cover portion 52 can be prevented from being crushed, cracked, or deformed when subjected to impact from any direction. Furthermore, the operation shaft 4, formed from duplex stainless steel or similar material, is fixed to the shaft locking portion 51. The method for fixing the operation shaft 4 to the shaft locking portion 51 is not particularly limited. For example, the operation shaft 4 may be placed in a mold, and the operation member 3 including the operation shaft 4 may be formed by insert molding. Alternatively, after forming the operation head 5, the operation shaft 4 may be fitted into the shaft locking portion 51. Once the operation member 3 is formed, the operation member 3, on the side with the operation shaft 4, is attached to the case 1, completing the switch device 2.

Specifically, the module 15 and the like are disposed inside the case 1. The watch glass 12 is attached to cover the upper opening of the case 1. Furthermore, the outer casing member 13 is fitted from the top side over the side surfaces of the case 1. In this step, the outer casing member 13 is positioned relative to the case 1 such that the operation member mounting portions 17 fit within the respective through holes 131 of the outer casing member 13. Then, each operation member 3 is inserted from the outside into its corresponding through hole 131 from the side with the operation shaft 4. Furthermore, the operation shaft 4 is inserted through the through hole 18 of the operation member mounting portion 17, enabling the end portion 40 of the operation shaft 4 to press the contact portion of the module 15 and the like. The end portion 40 of the operation shaft 4 is secured against removal from the case 1 by means such as an E-ring (not shown). Furthermore, the lower opening of the case 1 is closed by the back cover member 14, completing the timepiece 100. In the embodiment, the band is attached to the band attachment portions 11, enabling the timepiece 100 to be worn on the wrist.

Even when the timepiece 100 including the switch device 2 according to the embodiment is dropped or strongly hit by an object, the connection portions 53, which are arranged nearly evenly around the operation shaft 4 (the shaft locking portion 51 to which the operation shaft 4 is fixed), prevent the cover portion 52 from being crushed, deformed, cracked, or destroyed, thereby maintaining the shape of the cover portion 52. Furthermore, the operation shaft 4 is formed from a high-strength material such as duplex stainless steel. This also prevents the operation shaft 4 from being bent or broken by impact. Consequently, even when the operation head 5 is designed to protrude from the case 1, malfunctions of the operation member 3 are less likely to occur.

As described above, the switch device 2 according to the present embodiment includes: the case 1 that has the through hole 18 penetrating through the inside to the outside; and the operation member 3 that includes the operation shaft 4, one end of the operation shaft 4 being inserted in the through hole 18 of the case 1 from the outside of the case 1, and the operation head 5 that is fixed to the other end of the operation shaft 4 and formed from resin. The operation head 5 of the operation member 3 includes: the shaft locking portion 51 fixed to the operation shaft 4; and the cover portion 52 covering at least a portion of the outer periphery of the shaft locking portion 51. The cover portion 52 and the shaft locking portion 51 are partially connected to each other via the connection portions 53. By connecting the cover portion 52 to the shaft locking portion 51 via the connection portions 53, the umbrella-shaped cover portion 52 is less likely to be crushed, deformed, cracked, or broken when subjected to an external impact, thereby maintaining appearance quality. This eliminates the need to protect the operation member 3, particularly the operation head 5, with a button guard or the like, allowing greater freedom in the placement of the operation member 3 and the design of each component.

For example, when the head of the operation member protrudes to the outside of the case, there is a risk that the head or other portion of the operation member could be destroyed upon receiving an external impact. The present invention addresses and solves the problems in such situations, providing a switch device and a timepiece capable of preventing the destruction of operation members even when the timepiece is subjected to impact.

By configuring the timepiece as described in the embodiment, the effect of preventing the destruction of the operation members even when the timepiece is subjected to impact is achieved.

Furthermore, each of the connection portions 53 in the embodiment is a thin-walled rib. When components and the like are formed by injection molding of resin, the thicker the resin, the more likely it is that depressions called "sink marks" will form on the surface of the molded product as the resin cools and solidifies. In this regard, in the embodiment, the shaft locking portion 51 and the cover portion 52 are connected to each other via the thin, rib-like connection portions 53. This allows for increased strength of the operation head 5 while enabling the operation head 5 itself to be thin-walled. Consequently, for example, compared to a configuration in which the interior of the umbrella-shaped cover portion 52 is filled with resin to increase strength, this configuration makes the surface less prone to sink marks while achieving similar strength improvement.

The connection portions 53 are provided in a substantially cross-shaped manner to surround the operation shaft 4 when viewed in the axial direction of the operation shaft 4 toward the operation head 5. This enables the cover portion 52 and the like to withstand impacts from any direction, preventing damage such as crushing, cracking, or deformation of the cover portion 52 and other components. The switch device 2 in the timepiece 100 is particularly susceptible to an impact from the top side of the timepiece 100 (front side, visible side, side facing the watch glass 12) when the timepiece 100 is dropped or otherwise impacted. In other words, it is relatively rare for the timepiece 100 to be dropped from the side, and when the timepiece 100 is dropped from the back (bottom) side, the band acts as a buffer to soften the impact. In contrast, when the timepiece 100 is dropped from the top side, the operation member 3 is most susceptible to receiving a strong impact from the top side. In this regard, by reinforcing the operation head 5 with the connection portions 53 provided nearly evenly around the shaft, even a configuration in which the operation member 3 rotates freely around its axis can withstand impacts from the top side of the timepiece 100.

Furthermore, the operation shaft 4 according to the embodiment is formed from a metallic material. Specifically, in the embodiment, the operation shaft 4 is formed from a high-strength material such as duplex stainless steel. This prevents the operation shaft 4 from being bent or broken by impact, thereby reducing the likelihood of switching malfunctions and other issues.

In the embodiment, of the operation member 3, at least the operation head 5 protrudes from the side surface of the outer surface of the case 1. When the operation member 3 is not protected by a button guard or the like and protrudes outward, there is a risk that the operation member 3 may be directly impacted when the timepiece 100 is dropped or otherwise impacted. In this regard, in the embodiment, by connecting the cover portion 52 to the shaft locking portion 51 via the connection portions 53, the umbrella-shaped cover portion 52 is less likely to be crushed, deformed, cracked, or broken when subjected to an external impact. This allows for a design where the operation head 5 protrudes from the case 1 while preventing malfunctions of the operation member 3, thereby enhancing design freedom.

Furthermore, when the timepiece 100 includes the switch device 2 according to the embodiment and the module 15 housed inside the case 1, the operation member 3 is not deformed even when subjected to impact, maintaining excellent appearance and enhancing the design freedom of the timepiece 100. Additionally, the improved impact resistance of the operation member 3 reduces the likelihood of switching malfunctions when the timepiece 100 is subjected to impact.

Although an embodiment of the present invention is described above, the present invention is not limited to the embodiment and can be appropriately modified in a variety of aspects without departing from the scope of the present invention.

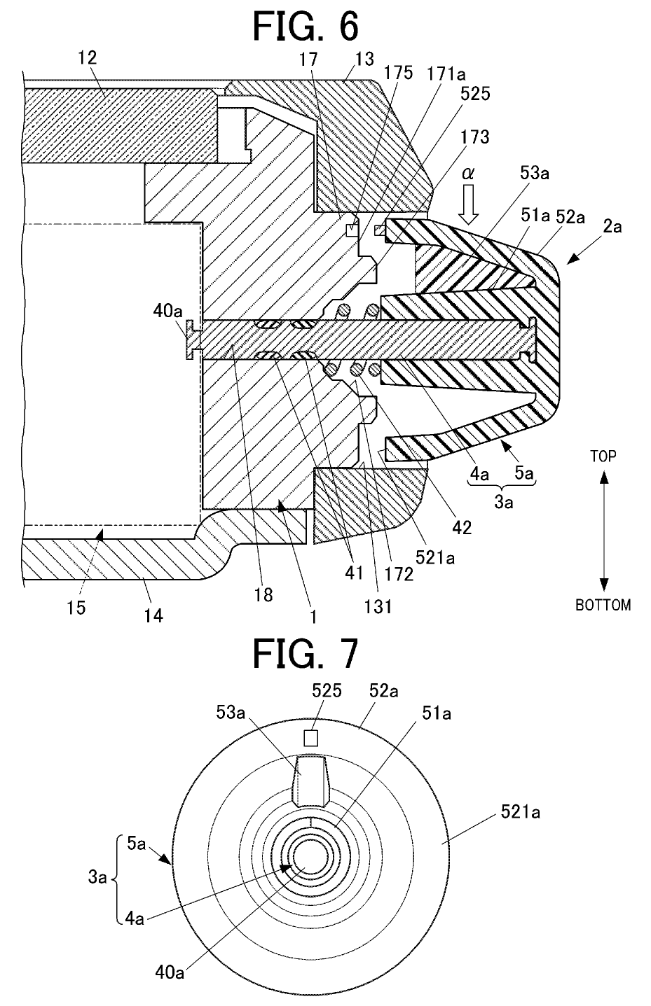

For example, the above embodiment illustrates a case in which the connection portions 53 are provided at four locations in a substantially cross-shaped manner to surround the operation shaft 4 when viewed in the axial direction of the operation shaft 4 toward the operation head 5. However, the arrangement of the connection portions 53 is not limited to this configuration. For example, as illustrated in FIGS. 6 and 7, a connection portion 53a of an operation member 3a may be provided at least at a location corresponding to the front side of the timepiece (upper side in FIG. 6) when viewed in the axial direction of an operation shaft 4a toward an operation head 5a. As mentioned earlier, the switch device 2 in a timepiece receives a large impact particularly from the top side of the timepiece (front side, visible side, side facing the watch glass 12) when the timepiece is dropped or otherwise impacted. In this regard, when the switch device 2 includes a push-button switch provided in the timepiece, the switch is not intentionally rotated like a crown. Therefore, positioning the connection portion 53a at a location corresponding to the front side of the timepiece (upper side in FIG. 6) can be expected to prevent damage or deformation of the operation head 5a. Furthermore, when the operation member 3a is additionally provided with a rotation restriction structure that restricts rotation of the operation shaft 4a around its axis, the operation member 3a can reliably withstand impacts from the front side of the timepiece (upper side in FIG. 6), and an effect of preventing deformation or the like can be expected.

As an example of the rotation restriction structure, as illustrated in FIG. 7, a protrusion 525 is provided on the end face 521 of the cover portion 52 on the side facing the case 1. Furthermore, a recess 175 is provided on the end face 171 of the operation member mounting portion 17 of the case 1, at a position corresponding to the protrusion 525 of the cover portion 52. The protrusion 525 and the recess 175 need only have corresponding shapes that fit into each other, and their specific shapes are not limited. Alternatively, the shape of the cover portion 52, as viewed from the axial direction of the operation shaft 4, may be rectangular. By employing any of these structures, rotation of the operation member 3 can be restricted. Note that the rotation restriction structure is not limited to the examples illustrated here. For instance, a protrusion may be provided on the end face 171 of the operation member mounting portion 17, with a corresponding recess formed on the end face 521 of the cover portion 52.

Furthermore, the connection portions connecting the cover portion 52 to the shaft locking portion 51 may be provided at four or more locations along the shaft circumference. In this case, the connection portions may be arranged nearly evenly around the shaft. However, as illustrated in FIG. 7, when a rotation restriction structure is provided to restrict rotation of the operation shaft 4 around its axis, a plurality of connection portions may be concentrated at locations corresponding to the front side of the timepiece (upper side in FIG. 6). This ensures reliable protection against impacts from the front side of the timepiece (upper side in FIG. 6), thereby preventing deformation, destruction, and similar damage.

Furthermore, the operation member need not necessarily include a push-button switch. For example, the operation member may be a crown that includes an operation head and a winding stem serving as an operation shaft and that performs switching or other operations when rotated. Furthermore, when the operation member is intended to rotate around its axis like a crown, it is preferable to provide a structure capable of withstanding impacts from all directions. For example, as illustrated in FIG. 4, when viewed in the axial direction of the operation shaft 4 toward the operation head 5, it is desirable to arrange the connection portions 53 substantially evenly around the axis in the circumferential direction, surrounding the operation shaft 4.

The operation shaft 4 is not limited to being formed from a material with higher strength than conventional materials, as in the embodiment. For example, when increasing strength by making the shaft diameter of the operation shaft larger than conventional designs, materials such as ordinary SUS (stainless steel) may be used.

Furthermore, it is not essential to provide the outer casing member 13 covering the top side and the side surfaces of the case 1. For example, the operation member 3 may be directly exposed to the outside from the operation member mounting portion 17 of the case 1. Moreover, it is also not essential to provide the operation member mounting portion 17. The operation shaft 4 of the operation member 3 may be directly mounted to a through hole provided on the side surface of the case 1. In these cases, the operation member 3 protrudes from the side surface of the outer surface of the case 1 further than in the examples illustrated in FIGS. 1 and 2, for example. Even with such a configuration, the switch device 2 with the configuration of the embodiment can withstand external impacts. In other words, the switch device 2 according to the embodiment allows the appearance quality to be maintained by preventing damage such as crushing, cracking, or deformation of the operation head 5 and the like, while also preventing the operation shaft 4 from being broken or bent, thereby avoiding switching failures.

Furthermore, the shape, arrangement, and range of the connection portions 53 are not limited to the illustrated examples. The connection portions 53 need only be such that the connection portions 53 do not affect the appearance of the operation member 3 and prevent damage such as crushing, cracking, deformation, or the like of the operation head 5 when impact is applied to the operation member 3. For example, in FIG. 5 and the like, an example has been illustrated in which each of the connection portions 53 extends from the base end side of the shaft locking portion 51 protruding from the cover portion 52 to the opening side of the cover portion 52. However, as long as the impact resistance of the operation member is not affected, there may be gaps, where the connection portions 53 are not provided, in a portion of the base end side of the shaft locking portion 51 or the like.

Variations of the embodiment will be described below. In the above embodiment, an example has been illustrated where the shape of the shaft locking portion 51 covers the entire circumference of the operation shaft 4. However, the shaft locking portion 51 is not limited to this structure. The shaft locking portion 51 may have any structure that is fixed to the operation shaft 4, provided it covers at least a predetermined angular region in the circumferential direction of the outer periphery of the operation shaft 4. For example, the shape of the shaft locking portion 51 may be a slit-shaped structure with a plurality of slits formed parallel to the axial direction of the operation shaft 4. In this case, the shaft locking portion 51 need only have an arc-shaped arc portion in a region corresponding to each of one or more connection portions 53, and the arc portion is connected to each connection portion 53. It is desirable for the width of the arc portion to be greater than the width of the connection portion 53, as this allows for stable fixation to the operation shaft 4. Alternatively, the shaft locking portion 51 may have a structure with a plurality of openings formed in a portion of the shaft locking portion 51. In this case too, the shaft locking portion 51 need only have a portion in a region corresponding to each of one or more connection portions 53, and the portion is connected to each connection portion 53. Thus, the shaft locking portion 51 connected to the connection portions 53 may be partially provided in the circumferential direction of the outer periphery of the operation shaft 4.

Furthermore, the switch device is not limited to that provided in a timepiece. Additionally, the timepiece 100 is not limited to having only a timepiece function. The timepiece 100 may also include various functions such as a pedometer, a heart rate meter, an altimeter, and a barometer or may be a so-called smart watch.

In the above, one or more embodiments of the present invention are described. However, the scope of the present invention is not limited thereto and includes the scope of the claims below and the scope of their equivalents.

1. A switch device comprising:
a case that has a through hole penetrating through an inside to an outside; and
an operation member that includes:
an operation shaft, one end of the operation shaft being inserted in the through hole of the case from the outside of the case; and
an operation head that is fixed to another end of the operation shaft, wherein
the operation head of the operation member includes:
a shaft locking portion that is fixed to the operation shaft by covering at least a predetermined angular region in a circumferential direction of an outer periphery of the operation shaft; and
a cover that covers at least a portion of an outer periphery of the shaft locking portion in an axial direction of the operation shaft, and
an inner peripheral wall of the cover is connected to the shaft locking portion via a rib.

2. The switch device according to claim 1, wherein the operation shaft is formed from a material harder than the operation head.

3. The switch device according to claim 1, wherein the rib is thin-walled.

4. The switch device according to claim 1, wherein
the rib includes a plurality of ribs, and
the plurality of ribs is provided in a cross-shaped manner to surround the operation shaft when viewed in the axial direction of the operation shaft toward the operation head.

5. The switch device according to claim 1, wherein
the switch device constitutes a push-button switch provided in a timepiece, and
the rib is provided at least at a location corresponding to a front side of the timepiece when viewed in the axial direction of the operation shaft toward the operation head.

6. The switch device according to claim 5, wherein the operation member has a rotation restriction structure that restricts rotation of the operation shaft around an axis of the operation shaft.

7. The switch device according to claim 1, wherein
the operation shaft is formed from a metallic material, and
the operation head is formed from a resin.

8. The switch device according to claim 1, wherein the case is formed from a material harder than the cover.

9. The switch device according to claim 1, wherein, of the operation member, at least the operation head protrudes from a side surface of an outer surface of the case.

10. The switch device according to claim 1, wherein an end face of the rib on a side facing the case is farther away from the case in the axial direction than an end face of the cover on a side facing the case.

11. A timepiece comprising:
the switch device according to claim 1; and
a module housed inside the case.

12. A method for manufacturing a switch device that includes:
an operation member that includes:
an operation shaft; and
an operation head that is fixed to one end of the operation shaft; and
a case that has a through hole penetrating through an inside to an outside,
the method comprising:
forming the operation head that includes:
a shaft locking portion;
a cover that covers at least a portion of an outer periphery of the shaft locking portion in an axial direction of the operation shaft; and
a rib that connects an inner peripheral wall of the cover to the shaft locking portion;
fixing the shaft locking portion to the operation shaft by the shaft locking portion covering at least a predetermined angular region in a circumferential direction of an outer periphery of the operation shaft; and
inserting another end of the operation shaft into the through hole from the outside of the case.

13. The method according to claim 12, wherein the operation shaft is formed from a material harder than the operation head.

14. The method according to claim 12, wherein the rib is thin-walled.

15. The method according to claim 12, wherein
the rib includes a plurality of ribs, and
the plurality of ribs is provided in a cross-shaped manner to surround the operation shaft when viewed in the axial direction of the operation shaft toward the operation head.

16. The method according to claim 12, wherein
the switch device constitutes a push-button switch provided in a timepiece, and
the rib is provided at least at a location corresponding to a front side of the timepiece when viewed in the axial direction of the operation shaft toward the operation head.

17. The method according to claim 16, wherein the operation member has a rotation restriction structure that restricts rotation of the operation shaft around an axis of the operation shaft.

18. The method according to claim 12, wherein
the operation shaft is formed from a metallic material, and
the operation head is formed from a resin.

19. The method according to claim 12, wherein the case is formed from a material harder than the cover.

20. The method according to claim 12, wherein, of the operation member, at least the operation head protrudes from a side surface of an outer surface of the case.
